(19) United States
(12) Patent Application Publication
(10) Pub. No.: US 2004/0227704 A1
(43) Pub. Date: Nov. 18, 2004

(54) Apparatus for improving yields and uniformity of active matrix oled panels

(76) Inventors: Wen-Chun Wang, Taichung (TW); Wen-Tui Liao, Taichung (TW); Hsi-Rong Han, Taichung Hsien (TW); Chien-Chung Kuo, Taichung Hsien (TW)

Correspondence Address: BIRCH STEWART KOLASCH & BIRCH, PO BOX 747, FALLS CHURCH, VA, 22040-0747, US

(21) Appl. No.: 10/437,291

(22) Filed: May 14, 2003

(51) Int. Cl. G09G 3/30

(52) U.S. Cl. 345/76

(57) ABSTRACT

An apparatus for improving yields and uniformity of active matrix organic light emitting diode (AMOLED) panels mainly adds a ballast resistor between a drive transistor and an organic light emitting diode (OLED) of each pixel. The ballast resistor can prevent short circuit of the drive transistor or excessive drive current in the pixel, and prevent the voltage source and the common electrode from directly occurring short circuit together when the OLED has occurred short circuit thereby improve yields and uniformity of the panel.

### FIELD OF THE INVENTION

The present invention relates to an apparatus for improving yields and uniformity of active matrix organic light emitting diode (AMOLED) panels that mainly targets problems occurred to conventional AMOLED array panels such as having abnormal short circuit or excessive current in the drive transistors of pixels caused by problems in manufacturing processes and particles and resulting in the voltage source being directly applied on the OLED that causes over lighting or piercing and short circuit of the OLED that further results in the voltage source being directly applied on the common electrode to cause dysfunction of the entire panel; or short circuits simultaneously occurring to the drive transistors and OLED in the pixels due to problems of manufacturing processes and particles and resulting in no lighting of OLED elements in the pixels and producing defects; or short circuits occurring to the OLED elements in the pixels due to problems of manufacturing processes and particles and resulting in no lighting of OLED elements in the pixels and producing defects. The invention adds a ballast resistor between the drive transistor and the OLED and provides a parallel redundant structure that consists of drive transistors, ballast resistors, OLEDs or a serial redundancy structure that includes a plurality parallel redundant sets that consist of drive transistors, ballast resistors and OLEDs to prevent the aforesaid problems from occurring thereby increase the yield of the panels and improve the display uniformity of the panels.

### BACKGROUND OF THE INVENTION

The pixel structure of array panels that adopts active matrix organic light emitting diode (AMOLED) is known in the art, such as U.S. Pat. No. 6,157,356 and the one shown in FIG. 1. The pixel unit 10 in the two examples consists of a switch transistor 1, a drive transistor 2, a storage capacitor 3 and an OLED 5. When the switch transistor 1 is conductive according to signals on the select line 6, data signals run through the data line 7 and the drain electrode and source electrode of the switch transistor and are stored in the storage element 3 (i.e. the conductive switch transistor charges the storage capacitor). In the mean time, according to the properties of the drive transistor 2, the bridging voltage of the storage element 3 determines the current of the drive transistor 2 that drives the OLED 5. According to the properties of the OLED 5, different driving currents actuate the OLED 5 to generate light of different intensity.

However, in the event of problems occurred in manufacturing process or presence of particles that results in abnormal short circuit or excessive current in the drive transistor 2 of the pixels, voltage source will be directly applied on the OLED and result in over lighting of the OLED or piercing that causes short circuit, and result in the voltage source (Vdd) 8 being directly applied on the common electrode. This could disable the entire panel from displaying pictures. Or short circuits might simultaneously occur to the drive transistors and OLED in the pixels due to problems of manufacturing processes and particles and result in no lighting of OLED elements in the pixels and producing defects. It could also happen that the OLED elements are short circuit due to problems of manufacturing processes and particles and result in no lighting of the OLED elements and produce defects.

### SUMMARY OF THE INVENTION

Therefore the primary object of the invention is to resolve the aforesaid disadvantages. The invention adds a ballast resistor between the drive transistor and the OLED. When short circuit or excessive current occurs to the drive transistor, the voltage source Vdd is not directly applied on the OLED, but rather passes through the resistor before applying on the OLED. Hence the voltage bridging the OLED may be reduced to prevent over lighting of the OLED or short circuit resulting from piercing caused by excessive current. In the event that short circuit occurs to the OLED, the ballast transistor prevents the voltage source and the common electrode from directly occurring short circuit together, thereby even if the whole panel has point defect, it still can display picture normally.

In order to achieve the foregoing object, the invention connects one end of the ballast resistor to the drain electrode of the drive transistor and another end connecting to the input end of the OLED.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the structure of a single pixel of a conventional AMOLED panel.

FIG. 2 is a schematic view of the structure of a first embodiment of a single pixel of the AMOLED panel of the invention.

FIG. 3 is a schematic view of a second embodiment of the invention.

FIG. 4 is a schematic view of a third embodiment of the invention.

FIG. 5 is a schematic view of a fourth embodiment of the invention.

FIG. 6 is a schematic view of a fifth embodiment of the invention.

FIG. 7 is a schematic view of a sixth embodiment of the invention.

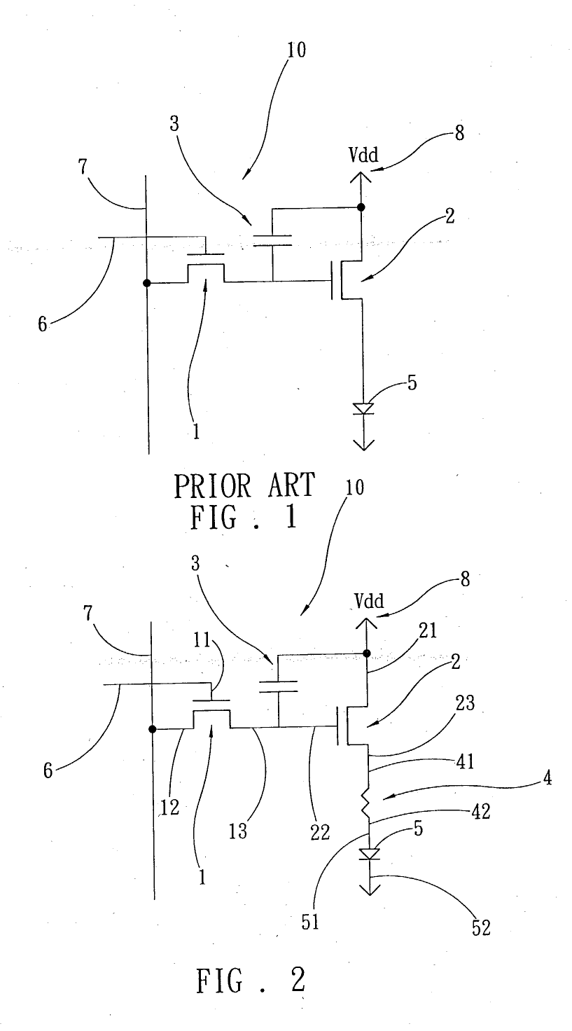

### DESCRIPTION OF THE PREFERRED EMBODIMENTS

Refer to FIG. 2 for the structure of a first embodiment of a pixel unit of the AMOLED array panel of the invention. The apparatus of the invention for improving the yield and uniformity of the AMOLED panel is to add a ballast resistor between the drive transistor and the OLED of every pixel unit. The ballast resistor can prevent a great amount of drain current from pouring from the voltage source Vdd to the common electrode when the drive transistor and the OLED are short that might cause the entire panel unable to display pictures.

To implement the apparatus mentioned above, the pixel unit 10 adopted in the invention includes a switch transistor 1, a drive transistor 2, a storage element 3, a ballast resistor 4 and an OLED 5.

The switch transistor 1 may be, but not limited to, a N-channel or P-channel metal oxide semiconductor field effect transistor (MOSFET) or thin film transistor (TFT). The switch transistor 1 has a gate electrode 11 and a drain electrode 12 connecting respectively to a select line 6 and a data line 7.

The drive transistor 2 may be, but not limited to, a N-channel or P-channel MOSFET or TFT (P-channel is shown in FIG. 2). The drive transistor 2 has a source electrode 21 connecting to a voltage source 8 and a gate electrode 22 connecting to a source electrode 13 of the switch transistor 1.

The storage element 3 may be, but not limited to, a capacitor which has one end connecting to the source electrode 21 of the drive transistor 2 and another end connecting to the juncture of the source electrode 13 of the switch transistor 1 and the gate electrode 22 of the drive transistor 2.

The ballast transistor 4 may be, but not limited to, a resistor or an element which has resistance properties, or a variable resistor which has adjustable resistance. The ballast transistor 4 has one end 41 connecting to the drain electrode 23 of the drive transistor 2 and another end 42 connecting to the input end 51 of the OLED 5.

The OLED 5 has the input end 51 connecting to one end 42 of the ballast resistor 4 and an output end 52 connecting to the common electrode.

When the pixel unit is being selected, the switch transistor 1 becomes conductive depending on the signal power of the select line 6. In the mean time, data signal is transmitted from the data line 7 through the drain electrode 12 and source electrode 13 of the switch transistor 1, and is stored in the storage element 3 (i.e. charge the capacitor after the switch transistor becomes conductive). According to the properties of the drive transistor 2, the bridging voltage of the storage element 3 determines the amount of current which the drive transistor 2 drives the OLED 5. And according to the properties of the OLED 5, different drive currents actuate the OLED 5 to generate lights of different intensities. In the event of problems occurred resulting from the manufacturing processes or particles that cause short circuit or excessive current occurring to the drive transistor 2, the addition of the ballast resistor 4 between the drive transistor 2 and the OLED 5 prevents the voltage source Vdd 8 from directly applying on the OLED 5. Instead, the ballast resistor 4 is applied before reaching the OLED 5. Thus the voltage bridging the OLED 5 may be reduced, and over lighting of the OLED 5 or short circuit resulting from piercing may be prevented. Even if short circuit occurs to the OLED 5, the addition of the ballast resistor 4 can prevent the voltage source 8 and the common electrode from directly occurring short circuit together. Thus the entire panel can still display pictures normally even with point defect.

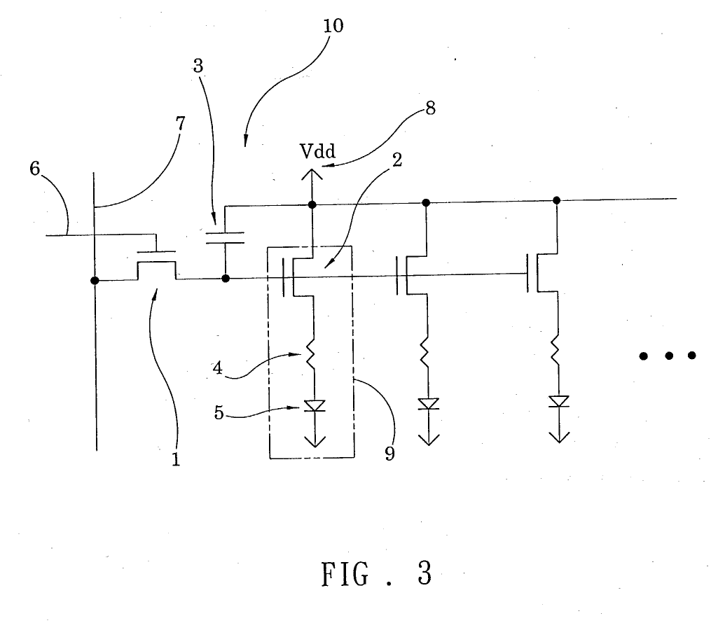

Refer to FIG. 3 for a second embodiment of the invention. In this embodiment, the drive transistor 2, the ballast resistor 4 and the OLED 5 of the pixel unit 10 form a redundancy serial circuit 9. A plurality of the redundancy serial circuits 9 are provided. Hence if one set of the drive transistor 2 and the OLED 5 is short circuit, the ballast resistor 4 prevents the voltage source 8 and the ground from directly occurring short circuit together. Other sets of the drive transistor 2, ballast resistor 4 and OLED 5 of the redundancy serial circuits in the pixel can still function normally (other OLED elements in the pixel unit can still generate light). Thus the panel can be prevented from occurring point defect.

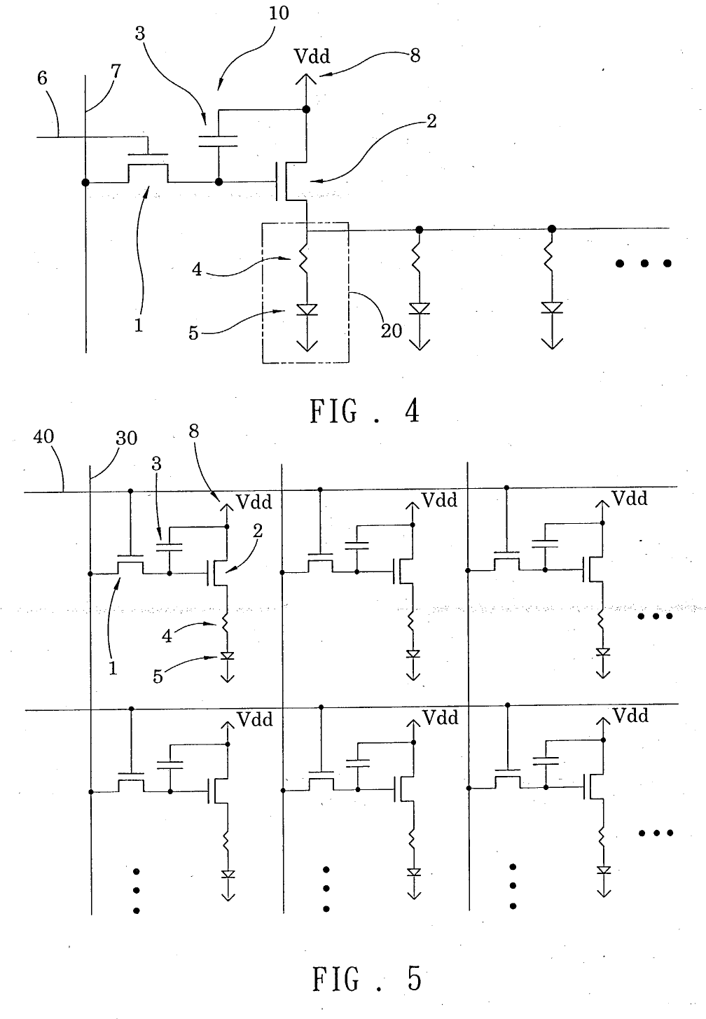

Refer to FIG. 4 for a third embodiment of the invention. In this embodiment, the resistor element 4 and the OLED 5 of the pixel unit 10 form a redundancy serial circuit 20. A plurality of the redundancy serial circuits 20 are provided. Hence if one OLED 5 is short circuit, the ballast resistor 4 prevents the drain electrode 23 of the drive transistor 2 and the common electrode from directly occurring short circuit and causing a great variation of drive current. Other sets of the ballast resistor 4 and OLED 5 of the redundancy serial circuits in the pixel can still function normally (other OLED elements can still generate light). Thus the panel can be prevented from occurring point defect.

Refer to FIG. 5 for a fourth embodiment of the invention. In this embodiment, a plurality of pixel units 10 are laid in an array fashion to form an OLED panel structure. The gate electrodes 11 of the switch transistor 1 of the pixel units 10 of the same column are connected to a select line 40, while the drain electrodes 12 of the switch transistor 1 of the pixel units 10 of the same row are connected to a data line 30.

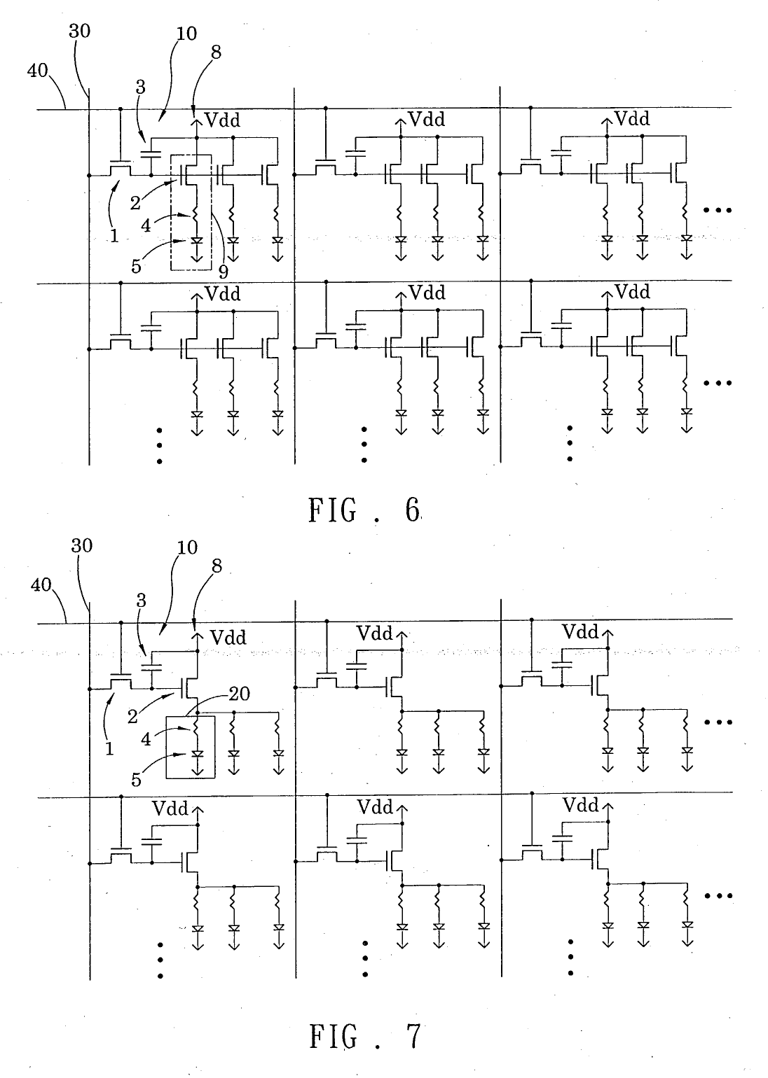

Refer to. FIG. 6 for a fifth embodiment of the invention. In this embodiment, the pixel units 10 that include a plurality of redundancy serial circuits 9 each consisting of a drive transistor 2, ballast resistor 4 and OLED 5 are connected to form an integrated OLED panel structure. The gate electrodes 11 of the switch transistors 1 of the pixel units of the same column are connected to a select line 40, while the drain electrodes 12 of the switch transistors 1 of the pixel units 10 of the same row are connected to a data line 30. In the event that any set of drive transistor 2 and OLED 5 of every pixel unit 10 are short circuit, the ballast resistor 4 can prevent the voltage source 8 and the common electrode from directly occurring short circuit together, while other sets redundancy serial circuits that contain the driver transistor 2, ballast resistor 4 and OLED 5 can still function normally (other OLED elements can still generate light). Thus the panel can be prevented from occurring point defect.

Refer to FIG. 7 for a sixth embodiment of the invention. In this embodiment, the pixel units 10 that include a plurality of redundancy serial circuits 20 each consisting of a ballast resistor 4 and an OLED 5 are connected to form an integrated OLED panel structure. The gate electrodes 11 of the switch transistor 1 of the pixel units 10 of the same column are connected to a select line 40, while the drain electrodes 12 of the switch transistor 1 of the pixel units 10 of the same row are connected to a data line 30. In the event that any one OLED 5 is short circuit, the ballast resistor 4 can prevent the drain electrode 23 of the drive transistor 2 and the common electrode from directly occurring short circuit and causing a great variation of drive current. Thereby other sets of serial circuits that consist of the ballast resistor 4 and OLED 5 can still function normally (other OLED elements can still generate light). Thus the panel can be prevented from occurring point defect.

In addition, when the ballast resistor 4 is adopted on the cathode end or anode end of a passive matrix OLED, the cross-talk problem can also be improved.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An apparatus for improving yields and uniformity of an active matrix organic light emitting diode (AMOLED) panel which consists of a plurality of pixel units, each of the pixel units comprising:
a switch transistor having a gate electrode, a drain electrode and a source electrode, the drain electrode and the gate electrode connecting respectively to a data line and a select line;
a drive transistor having a gate electrode, a drain electrode and a source electrode, the source electrode connecting to an input end of a voltage source, the gate electrode connecting to the source electrode of the switch transistor;
a storage element having one end connecting to the source electrode of the drive transistor or a common electrode and another end connecting to the source electrode of the switch transistor and the gate electrode of the drive transistor;
a ballast resistor having one end connecting to the drain electrode of the drive transistor; and
an organic light emitting diode (OLED) having an input end connecting to another end of the ballast resistor and an output end connecting to a common electrode;
wherein the ballast resistor prevents the voltage source and the common electrode from occurring short circuit together when short circuit has occurred to the drive transistor and the OLED of the pixel unit so that the entire panel is still functioning normally regardless existing of point defect.

2. The apparatus of claim 1, wherein the switch transistor and the drive transistor are selectively N-channel or P-channel metal oxide semiconductor field effect transistors (MOSFETs) or thin film transistors (TFTs).

3. The apparatus of claim 1, wherein the storage element is a capacitor.

4. The apparatus of claim 1, wherein the ballast resistor is a resistor.

5. The apparatus of claim 1, wherein the ballast resistor is a variable resistor.

6. The apparatus of claim 1, wherein the ballast resistor is an element which has resistance properties.

7. An apparatus for improving yields and uniformity of an active matrix organic light emitting diode (AMOLED) panel which consists of a plurality of pixel units, each of the pixel units comprising:
a switch transistor which has a gate electrode, a drain electrode and a source electrode, the drain electrode and the gate electrode connecting respectively to a data line and a select line;
a redundancy serial circuit connecting to the source electrode of the switch transistor; and
a storage element having one end connecting to a voltage source of the redundancy serial circuit and another end connecting to the source electrode of the switch transistor;
wherein the redundancy serial circuit prevents the panel from occurring point defect.

8. The apparatus of claim 7, wherein the redundancy serial circuit consists of a drive transistor, a ballast resistor and an OLED connecting in a serial fashion.

9. The apparatus of claim 8, wherein the drive transistor includes a gate electrode, a drain electrode and a source electrode, the source electrode connecting to the input end of the voltage source, the gate electrode connecting to the source electrode of the switch transistor and one end of the storage element, the drain electrode connecting to one end of the ballast resistor.

10. The apparatus of claim 8, wherein the ballast resistor has one end connecting to the drain electrode of the drive transistor and another end connecting to an input end of the OLED.

11. The apparatus of claim 8, wherein the OLED has an input end connecting to one end of the ballast transistor and an output end connecting to a common electrode.

12. The apparatus of claim 7, wherein each pixel unit connects to a plurality of the redundancy serial circuits.

13. An apparatus for improving yields and uniformity of an active matrix organic light emitting diode (AMOLED) panel which consists of a plurality of pixel units, each of the pixel elements comprising:
a switch transistor having a gate electrode, a drain electrode and a source electrode, the drain electrode and the gate electrode connecting respectively to a data line and a select line;
a drive transistor having a gate electrode, a drain electrode and a source electrode, the source electrode connecting to an input end of a voltage source, the gate electrode connecting to the source electrode of the switch transistor;
a storage element having one end connecting to the input end of the voltage source or a common electrode and another end connecting to the source electrode of the switch transistor and the gate electrode of the drive transistor; and
a redundancy serial circuit connecting to the drain electrode of the drive transistor for preventing point defect from occurring to the panel.

14. The apparatus of claim 13, wherein the redundancy serial circuit consists of a ballast resistor and an OLED.

15. The apparatus of claim 14, wherein the ballast resistor has one end connecting to the drain electrode of the drive transistor and another end connecting to the OLED.

16. The apparatus of claim 14, wherein the OLED has an input end connecting to one end of the resistor element and an output end connecting to a common electrode.

17. The apparatus of claim 13, wherein each pixel unit connects to a plurality of redundancy serial circuits.
